(19) United States
(12) Patent Application Publication
(10) Pub. No.: US 2004/0216796 A1
(43) Pub. Date: Nov. 4, 2004

(54) Flexible hose

(76) Inventors: Kouki Fukui, Takatsuki-shi (JP); Nobuo Shindo, Takatsuki-shi (JP); Hiroshi Ikegami, Takatsuki-shi (JP); Shigeto Tachibana, Takatsuki-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/806,365

(22) Filed: Mar. 23, 2004

(30) Foreign Application Priority Data
Mar. 24, 2003 (JP) 2003-80897
May 1, 2003 (JP) 2003-126200

(51) Int. Cl. F16L 11/00

(52) U.S. Cl. 138/129; 138/144; 138/150; 138/154

(57) ABSTRACT

A flexible hose of the invention has a hose wall which is formed by laminating resin layers. The resin layer acting as a gas barrier is formed by spirally winding a gas barrier resin strip and thermally fusing or bonding axially adjoining edges of the strip to each other. The resin layers are thermally fused or bonded to one another to become one piece.

### BACKGROUND OF THE INVENTION

1. Field of the Invention

The present invention relates to a flexible hose having preferable gas barrier characteristics to be suitable for use as various types of hoses requiring gas barrier such as a food transportation hose, a liquid fuel transportation hose and a refrigerant transportation hose.

2. Description of the Related Art

According to a known flexible gas barrier hose as illustrated in FIG. 4, wires 2 are wound around inner and outer surfaces of a laminated member 1 having gas barrier characteristics. The laminated member 1 is formed by winding a sheet having a predetermined width in multiple into a pipe shape, on which sheet gas barrier resin film is laminated. The laminated member 1 is sandwiched between the wires 2 so as to prevent the sheet of the laminated member 1 from being loosened. The flexible hose having this structure is disclosed in, for example, Japanese Utility Model Laid-Open Number 2-29383.

There is another known flexible gas barrier hose as illustrated in FIG. 5, in which a plurality of resin layers 5 and 6 are co-extruded into a pipe shape by an extruder and bonded to each other to become one piece. At least one of the resin layers 5 and 6 is a gas barrier layer. The flexible hose of this type is disclosed in, for example, Japanese Patent Laid-Open Number 2001-336679.

According to the flexible hose shown in FIG. 4 in which the laminated member 1 is formed by winding a sheet with a predetermined width in multiple into a pipe shape, the producible hose length is limited to the sheet width. Thus, the productivity of the hose of this type is low due to the limitation of the hose length.

When the hose shown in FIG. 4 is bent, the radially adjoining portions of the sheet of the laminated member 1 slip from each other so as to prevent the laminated film from being broken due to the stress generated by the bending of the hose. However, when the hose having this structure is cut at any portion for use, the sheet is loosened at the cut portion and the hose can be no longer used. This lowers the usability of the hose.

According to the flexible hose as illustrated in FIG. 5, the resin layers 5 and 6 extruded into a pipe shape are laminated to become one piece. This removes the limitation of the producible hose length and allows the hose to be cut at any portion.

However, for the gas barrier layer which is formed by extrusion into a pipe shape having substantially smooth inner and outer surfaces, it is difficult to have sufficient flexibility because the gas barrier resins are generally hard. If the gas barrier layer is formed as an extremely thin film for increasing flexibility, the gas barrier characteristic is lowered.

### SUMMARY OF THE INVENTION

Accordingly, for solving the aforementioned problems, an object of the present invention is to provide a flexible gas barrier hose having high productivity and usability. Another object of the invention is to provide a flexible gas barrier hose which maintains high flexibility without any loss of gas barrier characteristics. Still another object of the invention is to provide a flexible gas barrier hose which has a transparent hose wall allowing observation of the condition inside the hose and which is also environment-friendly.

To achieve the above objects, a flexible hose of a first aspect of the present invention has a hose wall formed by laminating a plurality of resin layers in a radial direction. At least one of the resin layers of the hose wall is a gas barrier layer formed by spirally winding a gas barrier resin strip and by thermally fusing or bonding axially adjoining edges of the strip to each other.

This structure allows the gas barrier layer to be formed continuously without a break in the axial direction. Thus, a hose having preferable gas barrier characteristics with indefinite length can be produced in succession, which enhances the productivity of the hose.

Moreover, since the gas barrier layer is formed by spirally winding the resin strip, the gas barrier layer can be easily made into a corrugated-form by corrugating the resin strip.

According to a flexible hose of a second aspect of the invention, the resin layers of the hose wall are thermally fused or bonded to one another to become one piece.

This structure allows the hose to be cut at any portion for use without giving any effect on the gas barrier characteristics of the hose, which enhances the usability of the hose.

According to a flexible hose of third and fourth aspects of the invention, the gas barrier layer is corrugated with concaves and convexes formed thereon continuously in the axial direction.

Since the gas barrier layer is corrugated, the gas barrier layer which is generally hard becomes highly flexible with no necessity of forming the gas barrier layer into an extremely thin film. This provides both high gas barrier characteristics and high flexibility to the hose, and also increases the toughness of the hose with enhanced flatness strength. Additionally, the bonding strength between the gas barrier layer and the resin layers to which the gas barrier layer is thermally fused and bonded is increased due to the enlarged contact area between the gas barrier layer and the resin layers, thus preventing exfoliation of the layers.

When the gas barrier layer is formed by extruding gas barrier resin into a pipe shape by an extruder as the conventional hose illustrated in FIG. 5, it is difficult to produce a corrugated gas barrier layer. According to the conventional hose shown in FIG. 4, the gas barrier laminated member is made corrugated by the tightening force of the wires. However, the necessity of providing the wires increases the number of components and complicates the manufacturing process.

According to a flexible hoses of fifth and sixth aspects of the invention, a soft resin layer is laminated on the outer surface and/or the inner surface of the gas barrier layer to level the concaves and convexes of the gas barrier layer and provide a smooth surface.

This structure reduces the pressure loss during fluid transportation, and facilitates the handling of the hose by decreasing catches with other members at the time of installation of the hose.

According to a flexible hose of seventh, eighth and ninth aspects of the invention, the respective resin layers of the hose wall are formed from non-chlorine transparent thermoplastic resin. More specifically, the gas barrier layer is formed from polyester resin. The layer laminated on the inner surface of the gas barrier layer is formed from urethane resin.

Since the respective resin layers of the hose wall are formed from non-chlorine resins, the flexible hose containing no polyvinyl chloride is environment-friendly. Besides, the transparent resin employed as the material for the resin layers of the hose wall permits easy observation of the transportation condition and the dirt or other contaminant within the hose from outside.

According to the present invention, the term “flexible hose” includes what is referred to as a tube or a pipe made from a relatively hard material.

### BRIEF DESCRIPTION OF THE DRAWINGS

FIG. 1 is a vertical section view showing a flexible hose of an embodiment according to the present invention.

FIG. 2 is an enlarged vertical section view showing a main part of the flexible hose in FIG. 1.

FIG. 3 illustrates a manufacturing process of the flexible hose shown in FIG. 1.

FIG. 4 is a vertical section view of a conventional flexible hose.

FIG. 5 is a vertical section view of another conventional flexible hose.

### DETAILED DESCRIPTION OF THE INVENTION

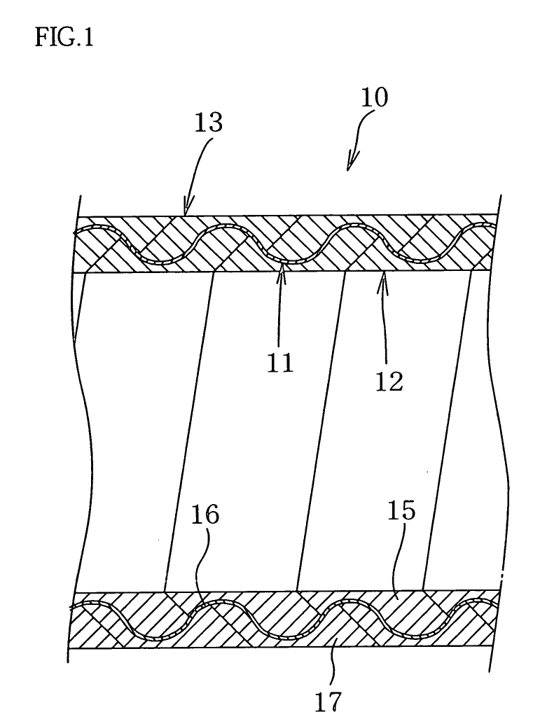

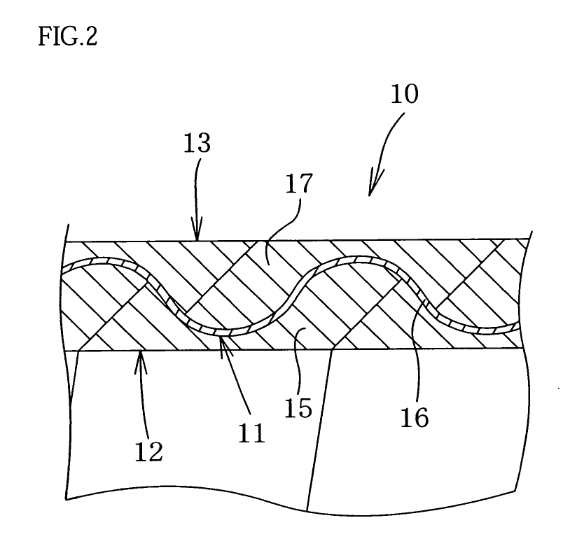

As illustrated in FIGS. 1 and 2, a flexible hose of an embodiment according to the present invention has a hose wall 10 which is formed by laminating an intermediate resin layer 11, an inner resin layer and an outer resin layers 12 and 13 in a radial direction. The intermediate resin layer 11 is sandwiched between the inner and outer resin layers 12 and 13.

The intermediate resin layer 11 is a hard layer formed from a gas barrier resin such as nylon 6 for securing the rigidity and the form-retainability of the hose. The intermediate resin layer 11 has an almost constant thickness and is corrugated with continuous concaves and convexes in the axial direction. This configuration allows the hose to maintain preferable flexibility without losing gas barrier characteristics. The intermediate resin layer 11 of this embodiment has concaves and convexes on both the inner and outer surfaces, but the concaves and convexes may be formed on only one of those surfaces continuously in a corrugated shape in the axial direction. Furthermore, the intermediate resin layer 11 may have partially thicker portions so as to enhance the flatness strength.

The gas barrier resin used as a material for the intermediate resin layer 11 is not limited to nylon 6 as described above, but may be polyamide resin other than nylon 6, saponified ethylene vinyl acetate copolymer, polyvinylalcohol resin, vinylidene chloride resin, polyester resin, polyacrylonitrile and other material. The material for the intermediate resin layer 11 may also be a mixture of these resins mixed appropriately. Moreover, the intermediate resin layer 11 may be formed by appropriately laminating these gas barrier resins according to the required level of gas barrier, or by laminating both these gas barrier resins and hard material having lower gas barrier characteristics but higher rigidity and toughness.

The inner resin layer 12 is formed from a soft resin material such as polyamide elastomer (polyether polyamide) which is highly compatible with nylon 6 as the material for the intermediate resin layer 11. The inner resin layer 12 is continuously formed in the axial direction, leveling the concaves and convexes of the inner surface of the intermediate resin layer 11 to provide a smooth inner surface of the hose. Thus, the inner surface of the inner resin layer 12 is almost smooth and the outer surface thereof is corrugated so as to fit with the inner surface of the corrugated intermediate resin layer 11.

The material for the inner resin layer 12 includes, other than polyamide elastomer as described above, polyethylene resin, polyvinyl chloride resin, polyurethane resin, olefinic elastomer such as ethylene-propylene copolymer, ethylene vinyl acetate copolymer, styrene thermoplastic elastomer such as styrene-butadiene-styrene, polyester elastomer, ethylene-vinylalcohol copolymer, chlorinated polyethylene, ethylene-ethylacrylate copolymer, acrylonitrile elastomer, polybutadiene-type resin, silicone resin and other material. The material for the inner resin layer 12 may also be a mixture of these resins appropriately mixed.

The outer resin layer 13 is made from a soft resin material similar to the material used for the inner resin layer 12. The outer resin layer 13 is continuously formed in the axial direction, leveling the concaves and convexes of the outer surface of the intermediate resin layer 11 to provide a smooth outer surface of the hose. Thus, the inner surface of the outer resin layer 13 is corrugated so as to fit with the outer surface of the corrugated intermediate resin layer 11 and the outer surface of the outer resin layer 13 is almost smooth.

As described above, the hose wall 10 of the flexible hose is formed by laminating the intermediate resin layer 11 and the inner and outer resin layers 12 and 13 in the radial direction. The materials for the respective resin layers 11, 12 and 13 may be selected appropriately from the above-listed resins and mixtures thereof according to their compatibilities with each other and the required characteristics.

For example, the material for the intermediate resin layer 11 as the gas barrier layer may be amorphous type transparent polyester resin having a gas barrier characteristics, the material for the inner resin layer 12 as a soft resin layer may be transparent urethane resin having high compatibility with polyester resin, alkali-resistance, toughness and abrasion resistance, and the material for the outer resin layer 13 as a soft resin layer may be transparent acrylic elastomer having high compatibility with polyester resin and weatherability. When this material combination is adopted, an environment-friendly flexible hose can be provided which is formed from non-chlorine material containing no polyvinyl chloride. Besides, the condition of the fluid transported through the hose and dirt or other contaminant present within the hose can be visually inspected with ease from outside through the transparent hose wall 10. Furthermore, hydrolysis of the intermediate resin layer 11 caused by alkali contained in the transported fluid and damage given to the intermediate resin layer 11 can be prevented by forming the inner resin layer 12 having high alkali resistance, toughness and abrasion resistance on the inner surface of the intermediate resin layer 11. This allows the intermediate resin layer 11 to maintain the gas barrier characteristics for a long period of time. Additionally, degradation of the flexible hose after the hose is exposed outside for use during prolonged periods can be decreased by forming the outer resin layer 13 having high weatherability on the outer surface of the intermediate resin layer 11.

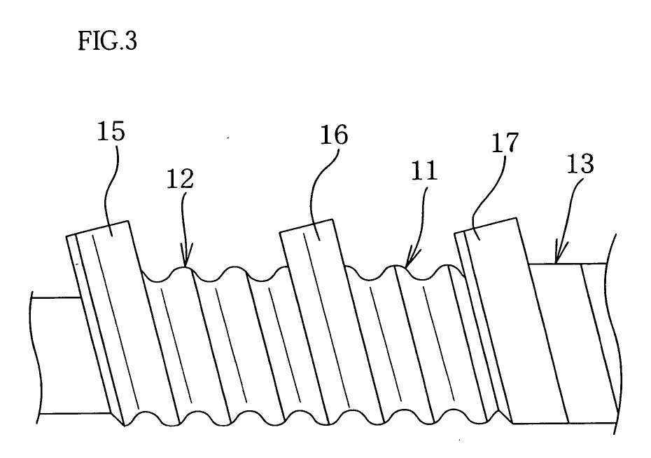

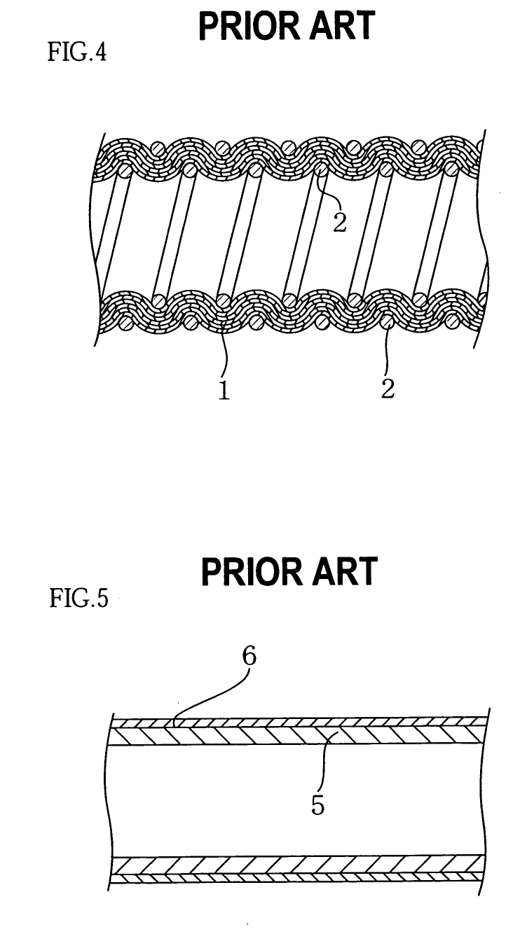

The method for manufacturing the flexible hose having the above structure is now described. As illustrated in FIG. 3, a soft resin strip 15 extruded from an extruder is spirally wound around a mandrel, and axially adjoining edges of the strip 15 are thermally fused or bonded to each other to form the inner resin layer 12.

Subsequently, a gas barrier hard resin strip 16 extruded from an extruder is spirally wound around the outer surface of the inner resin layer 12, and axially adjoining edges of the strip 16 are thermally fused or bonded to each other to form the intermediate resin layer 11 acting as the gas barrier layer. Finally, a soft resin strip 17 extruded from an extruder is spirally wound around the outer surface of the intermediate resin layer 11, and axially adjoining edges of the strip 17 are thermally fused or bonded to each other to form the outer resin layer 13.

Then, the resin layers 11, 12 and 13 are thermally fused to one another by the heat of the strips 15, 16 and 17 extruded from the extruder.

The formation of the hose is not limited to the above method in which the strips 15, 16 and 17 are spirally wound in sequence, but other method may be adopted. For example, the strips 15, 16 and 17 co-extruded into one piece may be spirally wound and the axially adjoining edges of the strips 15, 16 and 17 may be thermally fused or bonded to one another. This co-extrusion method prevents bubbles from being generated between the resin layers 11, 12 and 13 and improves the transparency of the hose wall 10 when the wall 10 is transparent.

When the thermal fusion between the resin material of the intermediate resin layer 11 and the resin materials of the inner and outer resin layers 12 and 13 is difficult to perform, the resin layers 11, 12 and 13 may be bonded to one another to become one piece through boding layers. For example, when the intermediate resin layer 11 is formed from nylon 6 and the inner and outer resin layers 12 and 13 are from olefinic elastomer, or when the intermediate resin layer 11 is formed from saponified ethylene vinyl acetate copolymer and the inner and outer resin layers are from olefinic elastomer, the resin layers 11, 12 and 13 maybe bonded to one another through bonding layers made from a material such as maleic acid modified polypropylene.

The scope of present invention is not limited to the particular embodiment shown and described herein, but various changes and modifications may be given to the embodiment without departing from the scope of the invention. For example, the hose wall structure of the flexible hose is not limited to triple-layered as in the embodiment, but may be double-layered or quadruple or more multiple layered.

1. A flexible hose comprising a hose wall formed by laminating a plurality of resin layers in a radial direction, at least one of said resin layers of said hose wall being a gas barrier layer formed by spirally winding a gas barrier resin strip and by thermally fusing or bonding axially adjoining edges of said strip to each other.

2. A flexible hose as set forth in claim 1, wherein said resin layers of said hose wall are thermally fused or bonded to one another to become one piece.

3. A flexible hose as set forth in claim 1, wherein said gas barrier layer is corrugated with concaves and convexes formed thereon continuously in the axial direction.

4. A flexible hose as set forth in claim 2, wherein said gas barrier layer is corrugated with concaves and convexes formed thereon continuously in the axial direction.

5. A flexible hose as set forth in claim 3, wherein a soft resin layer is laminated on the outer surface and/or the inner surface of said gas barrier layer to level the concaves and convexes of said gas barrier layer and provide a smooth surface.

6. A flexible hose as set forth in claim 4, wherein a soft resin layer is laminated on the outer surface and/or the inner surface of said gas barrier layer to level the concaves and convexes of said gas barrier layer and provide a smooth surface.

7. A flexible hose as set forth in claim 1, wherein the respective resin layers of said hose wall are formed from non-chlorine transparent thermoplastic resin.

8. A flexible hose as set forth in claim 7, wherein said gas barrier layer is formed from polyester resin.

9. A flexible hose as set forth in claim 8, wherein the layer laminated on the inner surface of said gas barrier layer is formed from urethane resin.

10. A flexible hose as set forth in claim 2, wherein the respective resin layers of said hose wall are formed from non-chlorine transparent thermoplastic resin.

10. A flexible hose as set forth in claim 3, wherein the respective resin layers of said hose wall are formed from non-chlorine transparent thermoplastic resin.

10. A flexible hose as set forth in claim 4, wherein the respective resin layers of said hose wall are formed from non-chlorine transparent thermoplastic resin.

10. A flexible hose as set forth in claim 5, wherein the respective resin layers of said hose wall are formed from non-chlorine transparent thermoplastic resin.

10. A flexible hose as set forth in claim 6, wherein the respective resin layers of said hose wall are formed from non-chlorine transparent thermoplastic resin.
